(19) United States
(12) Patent Application Publication
(10) Pub. No.: US 2014/0278323 A1
(43) Pub. Date: Sep. 18, 2014

(54) System and Method for Ecosystem Habitat Optimization

(71) Applicants: Wayne S. Wright, Seattle, WA (US); John T. Monahan, Bellingham, WA (US)

(72) Inventors: Wayne S. Wright, Seattle, WA (US); John T. Monahan, Bellingham, WA (US)

(21) Appl. No.: 14/210,216

(22) Filed: Mar. 13, 2014

Related U.S. Application Data
(60) Provisional application No. 61/785,065, filed on Mar. 14, 2013.

(51) Int. Cl. G06F 19/26

(52) U.S. Cl. CPC G06F 19/26
USPC 703/11

(57) ABSTRACT

Systems and methods for ecosystem habitat optimization modeling, particularly in aquatic systems. Hydraulic modeling output is combined with biological suitability criteria within a geospatial framework to produce geospatial and numeric output. Hybridizing output from a physical habitat simulation model is overlaid onto a visual platform with biologic criteria supporting morphological design and analysis.

### CROSS REFERENCE TO RELATED APPLICATIONS

This application claims priority to U.S. Provisional Application 61/785,065 filed Mar. 14, 2013 which is incorporated herein by this reference as if fully set forth.

### TECHNICAL FIELD

The invention relates to habitat modeling systems; more particularly, it relates to ecosystem habitat optimization systems and methods.

### BACKGROUND

Commonly used analytical models, design tools and monitoring approaches to mapping, analysis, design and monitoring of aquatic habitats are focused on hydrologic and hydraulic metrics, often in numeric format. For example, the scope of federal, state, tribal and utility fishery recovery initiatives across the river systems of WA, OR, ID, MT, and WY are extensive and cover six salmon species: Chinook, Chum, Coho, Pink, Steelhead and Sockeye; as well as other important salmonids such as bull trout and Yellowstone cutthroat trout; and non-salmonids like pacific lamprey.

There are many formulas and spreadsheet applications developed for assessing and monitoring existing streams and rivers. Existing data gleaned from research on known waterways are typically used in these assessments, often characterized as Natural Channel Design.

Belcher (U.S. Pat. No. 7,349,831) notes that river professionals have developed formulas and spreadsheet applications for assessing and monitoring existing streams and rivers, and that stored data pertaining to existing waterways can be useful in designing optimal dimensions for a disturbed (impacted) reach, or target stretch of water. Belcher notes such data conventionally includes data collected on a river or stream within the boundaries defined by approximately 20-30 bankfull widths along the thalweg and the breadth of the floodprone area. A thalweg comprises a line connecting the deepest points along a channel, and bankfull generally regards a stream discharge value at a point where the river just fills the banks of a stream channel.

Sprague (U.S. Pat. No. 7,353,113) notes that streams are complex ecosystems in which numerous biological, physical, and chemical processes interact. Sprague points out that changes in any one characteristic or process have cascading effects throughout the system and result in changes to many aspects of the system. For example, increased nutrient loads alone might not cause a change to a forested stream. But, when combined with tree removal and channel widening, the result is to shift the energy dynamics from an aquatic biological community based on leaf litter inputs to one based on algae and macrophytes. The resulting chemical changes caused by algal photosynthesis and respiration and elevated temperatures may further contribute to a completely different biological community.

Thus, notes Sprague, stream processes are typically in a delicate, dynamic balance, where for example, stream power, sediment load, and channel roughness must be in balance. Hydrologic changes that increase stream power, if not balanced by greater channel complexity and roughness, result in “hungry” water that erodes banks or the stream bottom. Increases in sediment load beyond the transport capacity of the stream leads to deposition, lateral channel movement into stream banks, and channel widening Structural complexity might be provided by trees that have toppled into the channel, overhanging branches, roots extending into the flow, pools and riffles, overhanging vegetation, and a variety of bottom materials. But most systems would benefit from increased complexity and diversity in physical structure and hydrologic regime because complexity enhances habitat for organisms, as well as restores hydrologic properties that often are lost to physical, biological and/or chemical changes in the system.

In general computerized systems are known for simulation, modeling and analysis of hydraulic conditions. Such modeling systems and simulations enable comparative evaluation of different system embodiments without the expense and time of building physical prototype systems.

What is needed however is a system and method for ecosystem habitat optimization that generates both visual and tabular output in habitat units for any desired aquatic species, combining hydraulic model output with biologic criteria within a geospatial framework to produce visual and numeric output.

### DISCLOSURE

A new system and method for ecosystem habitat optimization is disclosed. It is an innovative application developed to advance the mapping, analysis, design and monitoring of aquatic habitats. The disclosed system generates both visual and tabular output in habitat units for any desired aquatic species. The model is a unique ecohydraulic application, combining hydraulic model output with biologic criteria within a geospatial framework to produce visual and numeric output.

Results enable the user to evaluate how proposed or actual changes in flow, channel geometry, substrate, cover or water quality (e.g. water temperature) affect habitat quantity and quality for selected species. Animation technology enables the user to see steelhead or other species rearing habitat and patterns of change in habitat quantity and quality as flows vary, illustrated with a time-series analysis tool. For example, see FIGS. 6, 7 and 8. They are each single snapshot samples of a three figure output illustrating in succession the pre-design, proposed design and post-construction results respectively for a single species at a particular streamflow in a specific project area. Each figure corresponds to a different streamflow.

Flexibility, customization to specific sites and species, integration with habitat design approaches and accurate representation of habitat are hallmarks of the disclosed system. Any hydraulic project utilizing standard 1D or 2D models can be evaluated with the system.

For example, many hydraulic projects early in the design phase often require analysis with the conventional 1D Hydrologic Engineering Center-River Analysis System (HEC-RAS) model (provided by the US Army Corps of Engineers) to evaluate the existing and alternative future proposed hydraulic conditions in a channel. The disclosed system uses this HEC-RAS information plus more information from the field related to substrate and cover to generate flow-specific habitat maps of existing conditions to aid designers in avoiding unanticipated impacts or loss to instream habitat, as well as guiding the design of projects that optimize habitat benefits.

In one approach there is an advantageous merging of HEC-RAS and currently existing static physical habitat simulation methodologies (such as HEP, PHABSIM, RHABSIM, or tools associated with the Instream Flow Incremental Methodology) to effect the calculation of habitat as an iterative design process. Compared to conventional abstract processes, the disclosed methodology allows designers and owners to “See, Sum and Analyze” by incorporating species specific habitat preference criteria into hydraulic model output as an overlay onto a visual form or platform such as the Hydrologic Engineering Center's-Geographic River Analysis System (HEC-GeoRAS or GeoRAS). Habitat codes for various species are known and readily accessible, and from them, the disclosed system can calculate and show habitat changes for a variety of life forms across a continuum of flows and under varying restoration design alternatives. HEC-RAS is a desirable hydraulic tool. The disclosed system open new ground for tools like HEC-RAS, producing a previously unknown combination of Eco Hydrology and Eco Hydraulic technique.

The disclosed system allows designers to optimize habitat outcomes by demonstrating the synergistic relationships between habitat components like depth, velocity, cover, substrate and water temperature across a continuum of flows for a variety of species for any river segment. Alternatively, once a project is constructed, the site can be revisited and the original hydraulic cross sections re-measured to derive the amount of habitat that resulted from the project after the geomorphic response occurs in the river. In this way, the system provides quantitative results of hydraulic projects in units of species habitat, enabling the efficient analysis, design and monitoring of hydraulic projects in a way not previously possible with other methods and tools in the marketplace.

For the first time, a simple, accurate, repeatable and easy to understand model is available to assist with ecohydraulic analyses and the recovery of damaged aquatic habitats.

A system for habitat modeling is disclosed. Hydraulic modeling output is combined with biologic criteria within a geospatial framework to produce visual and numeric output. The hydraulic modeling output can advantageously be taken from HEC-RAS or the like 1D systems, or alternatively 2D systems, and the biological criteria can advantageously be obtained from published material or derived through consultation with local, state, federal or tribal experts associated with the target species. Stream morphological data obtained from topographic and bathymetric survey transects, Light Detection and Ranging (LiDAR), and the like, are also desirable for use in the disclosed process.

A method for ecosystem habitat optimization modeling is also disclosed. Hybridizing output from a physical habitat simulation model system is overlaid onto a visual platform with morphological data related to a selected waterbody. The waterbody morphological data comes from one or more morphological data sources such as topographic and bathymetric survey transects and LiDAR measurements and the like, or a combination of these.

Desirably, for any selected river segment, the hybridizing (and resultant output) is performed for each of a selected continuum of flow values, and is desirably applied to one or more selections from a variety of design alternatives (see sample list below), for any selected species of interest.

Generally the output of the physical habitat simulation system is for a selected species for the selected waterbody, and the modeling is advantageously extended across a continuum of flows for selected flow values in the continuum. Morphological data, where used for hybridizing for a selected species for a selected waterbody, is also derived from a variety of design alternatives.

An alternate process for habitat modeling is disclosed. The process includes at least the following habitat elements: depth, velocity, and substrate/cover. Each element is associated with its respective element data. Depth and velocity data are generally obtained from hydraulic models generated using a hydraulic modeling program, while substrate and or cover data is generally obtained from field observations.

The process has the following steps: depth and velocity data are converted into a raster GIS file ‘grid’ format, substrate/cover data are digitally mapped using polygons and converted to the grid format using a polygon to raster tool, each of the three resulting elemental grids is reclassified based on suitability criteria (from prepared preference curves or raw tabular data) for a specific species and life stage, and the resulting three suitability grids are then multiplied together within a suitable raster calculator. Suitability criteria can encompass species preference-based criteria and utilization-based criteria, as will be appreciated by those skilled in the art.

Desirably, hybridizing for a selected species for a selected stream section or waterbody is applied to one or more design selections such as modifying hydrology in the stream segment or waterbody, modifying channel geometry, increasing in-channel complexity with addition of wood, rock or other natural obstruction, creating wetlands, raising or lowering floodplain area, adding riparian or floodplain vegetation, modifying estuarine channel geometry, increasing estuarine complexity with the addition of wood, rock or other natural obstruction, or changing hydrology in the estuarine waterbody.

An alternate method for ecosystem habitat optimization modeling is disclosed. The method includes setting up a HEC-RAS (or other suitable 1D or 2D program) model that includes the following steps: partition each HEC-RAS transect into stream tubes representative of significant breaks such as changes in cross sectional profile and/or substrate type (where the selected hydraulic conditions are cross sectional profile, channel geometry or substrate type and the like), collect field-based or aerial photographic data for cover and derive habitat quantity and or quality values, calibrate the HEC-RAS model to a base low flow condition, or to selected flows where the breaks occur, adjusting roughness coefficients or other hydraulic factors to fit measured velocity and depth values generally, but can also include water surface elevation. This ‘fitting’ stage can also be thought of as a kind of percentage matching how roughness values or other hydraulic factors affect depth and velocity and surface elevation. Measured values, where needed, are desirably obtained from the field or alternatively obtained from a previous hydraulic model data set.

By “adjusting roughness coefficients to fit”, and in general the use of the term “fit”, is generally meant: adjusting to a fit greater than 60%, and desirably greater than 80% and more particularly to a fit greater than 90%.

Next, obtain desired species and life stage habitat preference or utilization criteria, generate a wetted perimeter relationship (or the like) for each stream segment of interest, and identify breakpoints where channel geometry, substrate or other hydraulic relationships pertaining to roughness change. Once calibration has been completed at each hydraulic break, HEC-RAS (or other hydraulic modeling system) results for each flow are then generated.

To calibrate the HEC-RAS model at flows where the breaks occur, adjust roughness coefficients so the HEC-RAS output depth and velocity or other hydraulic values fit to within 60% (see above) with comparable measured or observed values. Run HEC-RAS for all flow levels in between each calibration flow. Build a topographic map of the stream reach of interest within a suitable GIS platform. GeoRAS processing steps are generally used to convert HEC-RAS output into GeoRAS output within a GIS database to yield a grid platform upon which species and life stage habitat suitability criteria data are overlaid. For each calibration flow, the GeoRAS output is used to combine hydraulic output from GeoRAS with cover or substrate map data and suitability criteria for the selected species life history stage.

The model is desirably set up with an existing conditions model and a proposed conditions model, for pre execution design study and adjustment. In most cases, a suitable grid platform includes outputs for the calibration flow levels.

In the disclosed method it is desirable to set up a third model, a post-construction model. Advantageous comparative analyses of the existing condition model and the post-construction conditions model lead to insight about efficacy of the overall project.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a modeling process schematic for the disclosed processes.

FIG. 2 is a modeling data workup schematic for the disclosed processes.

FIG. 3 is a further modeling data workup schematic for the disclosed processes.

FIG. 4 is a graphical representation of a common static flow-driven physical habitat simulation method.

FIG. 5 is a graphical representation of HEC-RAS methodology.

FIG. 6 is a graphic output of the disclosed system and processes.

FIG. 7 is an alternate graphic output of the disclosed system and processes.

FIG. 8 is an alternate graphic output of the disclosed system and processes.

FIG. 9 is an alternate modeling process schematic for the disclosed processes.

FIG. 10 is an alternate modeling process schematic for the disclosed processes.

### DETAILED DESCRIPTION

FIGS. 1-3 illustrate in part a process for habitat modeling. FIG. 1 is a habitat grid process diagram. FIG. 2 is a feedback iteration process diagram. FIG. 3 is a copy raster process diagram.

In the FIG. 1 process illustrated, three habitat elements, among possible others, namely depth, velocity, and substrate/cover, are desirably used to model habitat area within disclosed habitat grid modeling process 100. Depth and velocity data associated with specific flows of interest in a subject aquatic system are obtained from hydraulic models generated using either 1 or 2 dimensional hydraulic modeling programs, such as the 1D hydraulic model HEC-RAS from the Corps of Engineers or 2D models like Hydronia's RiverFLO-2D. Substrate or cover information is obtained from field observations, or timely published studies such as tabular data and pre-existing suitability curves. Three habitat elements, depth, velocity, and substrate/cover, are illustrated and each element is associated with its respective element data.

It is not always necessary to use three physical elements, but the illustrated and disclosed three element combination has been found to be advantageous. Alternate combinations of physical element data are contemplated, having at least one element, and as many as four or five, or more.

Depth and velocity data are generally obtained from hydraulic models generated using various hydraulic modeling programs, such as those mentioned above, as will be appreciated by those skilled in the art. Substrate or cover data is generally obtained from field observations, but can also sometimes be reliably obtained from contemporaneously published studies of the waterbody selected for study and modeling.

These data sets, in concert with data from life species tables for depth and velocity 111 and 121, are then advantageously converted into ESRI's raster GIS file ‘grid’ format 112 and 122. (ESRI is a well known international supplier of GIS software and geodatabase management applications.) Converting depth and velocity data from HEC-RAS is done for example by using HECGeoRAS, a separate program within ESRI's ArcGIS platform, transforming the elements into ESRI's grid format. Like grids can also advantageously be created from other waterbody physical data, including morphological data.

Various 2 dimensional models that output X and Y point locations with associated depths and velocities can also be brought into ESRI's ArcGIS and transformed to grid format. The substrate/cover element, or other habitat element, is digitally mapped using polygons or other well-known methodology and converted to the ESRI grid format 130 using a polygon to raster tool to produce a further grid. This third habitat element is desirably delineated to just beyond the limits of the highest flow being analyzed.

Once in the grid format, each of the elemental grids is reclassified 101, 102 to a suitability curve or suitability criteria or indices for a specific species and life stage. The resulting three suitability grids 110, 120 and 130 are then multiplied together within ESRI's Raster Calculator 103 using weighted or non-weighted functions depending on desired scenarios and associated information and desired results, as will be appreciated by those skilled in the art, to obtain ‘nodata’ grid 140. Where additional grids are produced for modeling input, a like procedure is followed. ESRI's Model Builder (see 104, 105, 106 and 107) is used to automate these steps and string together a set of tools from ESRI's Spatial Analyst toolbox. The resulting habitat grid 150 represents habitat value per cell for the specified flow and species life stage. “NoData” values within the habitat grids are generally set to zero.

FIG. 2 illustrates a simple linear interpolation being performed between two habitat grids 210 and 220 generated from two modeled flows to obtain habitat values for flows not directly modeled within a hydraulic modeling program. This is done with ESRI's Model Builder, and the Feedback Iteration tool 200 within it, to automate the process and customize the names and appearance of the resulting grids.

This process generates a grid 250 representing habitat at incremental flows between the two modeled flows. Grid names should represent the flow values and desirably all have the same number of digits i.e. “existing_{—}001”, “existing_{—}099”, and “existing_{—}125”. This allows for ease of use later.

FIG. 3 illustrates how incremental and modeled grids 310 are brought into and stored in an ESRI raster catalog allowing a time series associated with the data to be generated and stored with the grids. ESRI's Animation tools are then advantageously used to generate a time series video. Two different time sequences can be generated. One is simply a progression of the incremental flows in the catalog. The second is a time sequence associated with a hydrograph. This requires building a second catalog with additional copies of grids (however many times a particular flow occurs on the hydrograph is the number of copies required in the catalog) each associated with a different time. To automate the copying process, ESRI's Model Builder 300 is used to string together the necessary tools. Once a catalog is brought into an .mxd file, a symbology is applied and a time value is generated and enabled. A time track for that catalog of grids can then be created and a video of the desired sequence is produced.

### Ecosystem Habitat Optimization Modeling

Process for setting up an existing conditions model:

First set up a HEC-RAS model. Partition each HEC-RAS transect into stream tubes representative of significant breaks in cross sectional profile and/or substrate type.

Collect field-based or aerial photographic data for cover (vegetation and structure—such as logs and boulders) to be used in deriving habitat quantity and quality values.

Calibrate HEC-RAS to a base low flow condition adjusting roughness coefficients to fit measured depth, velocity and water surface elevation. Measured values for depth, velocity, and substrate should be obtained directly from the field. The desired species and life stage habitat preference criteria and suitability indices are derived from field assessments, published documents or a consultation process.

Generate a wetted perimeter relationship for each stream segment of interest. This is a simple relationship between water depth and stream/river channel area. Identify breakpoints where the relationships change (based on morphological conditions such as elevation shifts or channel width shifts) and then generate HEC-RAS results for each flow where a break occurs. These breaks typically occur at the thalweg, the toe of the slope, and the top of the bank to obtain the minimum level of accuracy needed to complete the analysis.

After calibrating the model at the flows where these breaks occur to match how roughness values affect depth and velocity, then run HEC-RAS for all flow levels between each break. This completes the HEC-RAS model for the existing condition.

Use survey data or LiDAR to build a topographic map of the stream reach of interest within a suitable GIS platform and database.

Use GeoRAS processing steps to convert HEC-RAS output into GeoRAS output within the GIS database. This yields the grid platform upon which species specific (and life stage) habitat preference criteria or like data is applied. A suitable grid platform desirably includes the outputs for the calibration flow levels.

Using the GeoRAS output for each calibration flow, combine the hydraulic output from GeoRAS with cover or substrate map information and suitability criteria for the selected species life history stage. These results represent a system existing conditions calibration.

Perform linear interpolation between system calibration points to generate continuous system results for the selected stream reach and species. This yields a continuous record of habitat quantity and quality across the full range of modeled flows.

Results are desirably portrayed as 1 square-foot cells that have a numeric value between 0.0 and 1.0 representing the combined depth, velocity, cover and substrate suitability for the species habitat modeled. Because these results are in a GIS framework, multiple analyses can be performed to answer many questions regarding species and the related habitat management. For example the system can be used to calculate and predict total habitat areas over a flow range, for various restoration design alternatives, and over time in terms of quantity and quality.

Setting Up a Proposed Condition Model

To derive a proposed condition go back to HEC-RAS to modify channel geometry reflecting changes in the topographic information and channel cross-section as appropriate for the proposed instream or other treatment. With that HEC-RAS output, go back to step 5 (run HEC-RAS for all flow levels between each break) and repeat and generate a system proposed condition output.

In one study regarding juvenile steelhead rearing, the following table of comparative results was obtained.

TABLE 1

| | | Pre Condition | | Proposed Condition | | | Post Condition | | |
|---|---|---|---|---|---|---|---|---|---|
| | | Habitat | Habitat | Habitat | Habitat | % | Habitat | Habitat | % |
| | | Value | Unit | Value | Unit | Change | Value | Unit | Change |
| 10 | cfs | 543 | 20432 | 685 | 19812 | 126% | 1008 | 13287 | 186% |
| 50 | cfs | 2568 | 31053 | 3093 | 27394 | 120% | 3359 | 19553 | 131% |
| 100 | cfs | 4999 | 32710 | 5878 | 30037 | 118% | 5851 | 20696 | 117% |

As can be seen in this representative table, the system effects comparative results so that Proposed Condition calculations can be compared to Pre Condition calculations for design efficacy purposes, and then Post Condition results can be compared to both Proposed Condition predictions and Pre Condition initial data.

When the stream morphological data are obtained from transects, the disclosed modeling process can be advantageously run.

FIG. 4 is a graphical representation of a common static physical habitat simulation methodology.

FIG. 5 is a graphical representation of a typical application of HEC-RAS methodology.

FIG. 6 is a single snapshot sample of an output in three figures illustrating the methodology disclosed above. In succession the three figures, pre-design condition 610 with a total weighted habitat of 543 square feet, proposed design condition 620 with a total weighted habitat of 685 square feet and post-construction condition 630 with a total weighted habitat of 1008 square feet are graphically illustrated respectively for a single species at a streamflow of 10 cfs. Example locations of proposed engineered wood structures 622 and proposed engineered logjams 624 and engineered wood structures 632 and engineered logjams 634 are also illustrated.

FIG. 7 is a single snapshot sample of an output in three figures illustrating the methodology disclosed above. In succession the three figures, pre-design condition 710 with a total weighted habitat of 2568 square feet, proposed design condition 720 with a total weighted habitat of 3093 square feet and post-construction condition 730 with a total weighted habitat of 3359 square feet are graphically illustrated respectively for a single species at a streamflow of 50 cfs. Example locations of proposed engineered wood structures 722 and proposed engineered logjams 724 and engineered wood structures 732 and engineered logjams 734 are also illustrated.

FIG. 8 is a single snapshot sample of an output in three figures illustrating the methodology disclosed above. In succession the three figures, pre-design condition 810 with a total weighted habitat of 4999 square feet, proposed design condition 820 with a total weighted habitat of 5878 square feet and post-construction condition 830 with a total weighted habitat of 5851 square feet are graphically illustrated respectively for a single species at a streamflow of 100 cfs. Example locations of proposed engineered wood structures 822 and proposed engineered logjams 824 and engineered wood structures 832 and engineered logjams 834 are also illustrated.

All graphical results depicted in FIGS. 6-8 are complimentary to the tabular results illustrated in the Table 1 above.

FIG. 9 shows general ecosystem habitat optimization modeling system and process 900. Physical data 912 and biological suitability criteria 914 are input to geospatial modeling application 920 to generate numerical and or topographical output 940. System and process 900 is generally directed to a selected waterbody, which can be a selected stream or river segment or reach, or a selected portion of an estuary, or the like, as will be appreciated by those skilled in the art.

Physical data 912 is desirably an output from a hydrological modeling program such as HEC-RAS, but can also be morphological data related to the selected waterbody. Waterbody morphological data is obtained from one or more waterbody morphological data sources such as field survey transects or LiDAR measurements or a combination of such sources.

Where morphological data is employed as an input to modeling process 920, it can come from physical data modeling related modifying hydrology in the waterbody, modifying channel geometry, increasing in-channel complexity, creating wetlands, changing floodplain area, adding vegetation, modifying estuarine channel geometry, increasing estuarine complexity or changing hydrology in the estuarine waterbody, or the like, as will be appreciated by those skilled in the art.

Biological suitability criteria 914 are generally for a selected species for the selected waterbody and are advantageously obtained from the output of a physical habitat simulation system, but can be obtained from alternate sources as discussed herein. In the modeling process 920, the physical habitat simulation system output is overlaid onto a visual, generally topographic, platform to produce output 940. Alternate outputs include tabular and graphical presentations.

Modeling process 920 alternately includes extending the modeling across a continuum of flows for selected flow values in the continuum, in a manner that will be appreciated by those skilled in the art.

In FIG. 10 a geospatial modeling environment system 1000 for computer modeling an aquatic habitat is illustrated. Hydraulic modeling data input 1012 and biological criteria input 1014, both residing in memory 1010, are combined in suitable geospatial modeling application 1022 running on CPU 1020 to produce modeling output 1030 which is used to create output display 1040.

Data processing system 1000 executes geospatial modeling application program 1022 on a central processing unit 1020 to create a data structure modeling output 1030. First computer readable memory 1010 is on a machine readable storage media and contains inputs 1012, 1014 and optionally 1016 for application 1022. Memory 1010 is operatively connected to CPU 1020. Second computer readable memory 1030 is also operatively connected to CPU 1020 for holding data structure modeling output 1030. Memory structures 1010 and 1030 may advantageously be separate structures on separate machine readable storage media such as hard drives, or separate by means of data partitions or other well known memory separations on a single machine readable storage medium. The locations are shown as separate in FIG. 10 for ease of schematic presentation.

First computer readable memory 1010 desirably holds both hydraulic modeling data 1012 related to the physical habitat and biological criteria data 1014 related to a selected aquatic species for the habitat. Advantageously, memory 1010 also holds stream morphological data input 1016.

Instructions in application 1022 are executed to combine hydraulic modeling data 1012 with the biological criteria 1014 and optionally stream morphological data 1016 to produce modeling output 1030. Modeling output 1030 is one or more outputs such as geospatial output such as topographic maps and overlays and numeric output such as tables and graphs.

Hydraulic modeling data input 1012 is advantageously an output from a hydraulic modeling program such as the well-known 1D system HEC-RAS, but may also be a conventional 2D modeling system.

Stream morphological data input 1016 is obtained from survey transects or LiDAR measurements or the like, or a combination of these. Biological criteria input 1014 is obtained from one or more biological criteria sets such as output from a physical habitat simulation model or a published source of species specific habitat suitability criteria or an expert source of species specific habitat suitability criteria.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

We claim:

1. A system for computer modeling an aquatic habitat wherein a hydraulic modeling data input is combined with a biological criteria input within a geospatial modeling environment to produce a modeling output, the system comprising:
a data processing system executing a geospatial modeling application program on a central processing unit to create a data structure modeling output, at least a first computer readable memory residing on machine readable storage media containing input for the application and operatively connected to the central processing unit, and at least a second computer readable memory operatively connected to the central processing unit for holding the data structure modeling output;
the first computer readable memory containing hydraulic modeling data related to the habitat and biological criteria related to a selected aquatic species;
the system executing instructions in the application to combine the hydraulic modeling data with the biological criteria to produce the modeling output.

2. The system of claim 1 wherein the modeling output is one or more outputs selected from the group of outputs consisting of geospatial output and numeric output.

3. The system of claim 1 wherein the hydraulic modeling data input is an output from a hydraulic modeling program, and the biological criteria input come from one or more biological criteria sets selected from the group of biological criteria sets consisting of output from a physical habitat simulation model, a published source of species specific habitat suitability criteria, and an expert source of species specific habitat suitability criteria.

4. The system of claim 3 further comprising in the first computer readable memory a stream morphological data input, and the system executing instructions in the application to combine the stream morphological data input with the hydraulic modeling data and with the biological criteria to produce the modeling output; and
wherein the hydraulic modeling data input comes from HEC-RAS, the biological criteria input come from a physical habitat simulation model, and the stream morphological data input is obtained from one or more of the group of stream morphological data sources consisting of survey transects and LiDAR measurements.

5. The system of claim 4 wherein a conventional 2D modeling system is substituted for HEC-RAS.

6. A method for ecosystem habitat optimization modeling, the method comprising the steps of:
hybridizing output from a physical habitat simulation system to overlay onto a visual platform with morphological data related to a selected waterbody;
wherein the waterbody morphological data comes from one or more of the group of waterbody morphological data sources consisting of survey transects and LiDAR measurements.

7. The method of claim 6, wherein the output of the physical habitat simulation system is for a selected species for the selected waterbody, and further comprising the step of:
extending the modeling across a continuum of flows for selected flow values in the continuum.

8. The method of claim 7, wherein the morphological data for hybridizing for a selected species for a selected waterbody is derived from one or more design selections from the group of design selections consisting of modifying hydrology in the waterbody, modifying channel geometry, increasing in-channel complexity, creating wetlands, changing floodplain area, adding vegetation, modifying estuarine channel geometry, increasing estuarine complexity and changing hydrology in the estuarine waterbody.

9. A process for habitat modeling, the process having at least three habitat elements, the three elements comprising depth, velocity, and substrate/cover, each element associated with respective element data;
wherein depth and velocity data are obtained from hydraulic models generated using a hydraulic modeling program, and
wherein substrate or cover data is obtained from field observations;
the process having the following steps:
depth and velocity data are both converted into a raster GIS file ‘grid’ format to produce two resulting elemental grids,
substrate/cover data are digitally mapped using polygons and converted to grid format using a polygon to raster tool to produce a third elemental grid,
each of at least three resulting elemental grids is reclassified based on biological suitability criteria for a specific species and life stage of that species to produce at least three suitability grids, and
the resulting at least three suitability grids are then multiplied together within a conventional raster calculator.

10. The process of claim 9, wherein the biological suitability criteria are prepared from the set of biological suitability criteria data consisting of tabular data and pre-existing suitability curves.

11. A method for ecosystem habitat optimization modeling, the method comprising the steps of:
setting up a HEC-RAS model including the following steps:
partition each HEC-RAS transect into stream tubes representative of significant breaks in selected hydraulic conditions, where the selected hydraulic conditions are taken from the group of hydraulic conditions consisting of cross sectional profile, channel geometry and substrate type,
collect field-based data for cover and derive habitat quality values,
calibrate HEC-RAS to a base flow condition adjusting roughness coefficients to fit at least one measured value, the measured value taken from the set of measured values consisting of velocity, depth and water surface elevation,
obtain desired species and life stage habitat suitability criteria,
generate a wetted perimeter relationship for each stream segment of interest, and
identify breakpoints where the hydraulic conditions change and then generate HEC-RAS results for each flow where a break occurs;
calibrating the HEC-RAS model at flows where the breaks occur;
building a topographic map of the stream reach of interest within a suitable GIS platform;
using GeoRAS processing steps to convert HEC-RAS output into GeoRAS output within a GIS database to yield a grid platform; and
overlaying on the grid platform selected species and life stage habitat suitability criteria data.

12. The method of claim 11 wherein a conventional 2D modeling system is substituted for HEC-RAS.

13. The method of claim 11 where the model set up is an existing conditions model.

14. The method of claim 13 where a second model is set up and the second model set up is a proposed conditions model and the system further comprises the step of comparative analyses of the existing condition model and the proposed condition model.

15. The method of claim 13 where a third model is set up and the third model is a post-construction model and the system further comprises the step of comparative analyses of the existing condition model and the post-construction conditions model.

16. The method of claim 11 where a suitable grid platform includes outputs for the calibration flow levels.

17. The method of claim 11 wherein, for the step of calibrating HEC-RAS to a base flow condition adjusting roughness coefficients to fit a measured value, the measured value is obtained from the set of measured value sources consisting of measured values obtained directly from the field and measured values obtained from a previous physical habitat model data set.

18. The method of claim 11 wherein, for the step of calibrating HEC-RAS to a base flow condition, roughness coefficients are adjusted to fit to greater than 60% accuracy the at least one measured value.

19. The method of claim 17 wherein, for the step of calibrating HEC-RAS to a base flow condition, roughness coefficients are adjusted to fit to greater than 80% accuracy the at least one measured value.

20. The method of claim 11 further comprising the step, for each calibration flow, of using the GeoRAS output to combine hydraulic output from GeoRAS with cover, substrate, or water quality map data and suitability criteria for the selected species life history stage.
